(19) United States
(12) Patent Application Publication
(10) Pub. No.: US 2026/0115651 A1
(43) Pub. Date: Apr. 30, 2026

(54) Combined Inert Gas and Instrument Air System for Marine Applications

(71) Applicant: Air Products and Chemicals, Inc., Allentown, PA (US)

(72) Inventors: Hallgeir Dalane Angel, Kristiansand (NO); Rune Damsgaard, Kristiansand (NO); Christer Haugland, Kristiansand (NO); Atle Hjemdal, Mandal (NO); Rune Holmer, Kristiansand (NO)

(73) Assignee: Air Products and Chemicals, Inc., Allentown, PA (US)

(21) Appl. No.: 18/929,759

(22) Filed: Oct. 29, 2024

(51) Int. Cl. B01D 53/22; B01D 53/00; B01D 53/04; B01D 53/047

(52) U.S. Cl. CPC B01D 53/229; B01D 53/002; B01D 53/0462; B01D 53/047; B01D 2253/116; B01D 2256/10; B01D 2257/104; B01D 2257/80; B01D 2258/06

(57) ABSTRACT

Disclosed herein are systems and methods for producing inert gas and utility air onboard a marine vessel or platform. The systems and methods utilize a plurality of nitrogen generators for producing inert gas, a plurality of air dryers for generating utility air, a plurality of sources of compressed air, and flow control means operable to selectively prevent or allow flow of compressed air from each of said sources of compressed air to each of said nitrogen generators and air dryers. During operation, at any one time one of the nitrogen generators is in use and one is not and one of the air dryers is in use and one is not, with the flow control means operating to direct flow of compressed air to whichever nitrogen generator is in use and whichever air dryer is in use.

### BACKGROUND

The present invention relates to systems and methods for use onboard a marine vessel or platform for producing inert gas and utility air for use onboard the vessel or platform.

Equipment onboard a ship is defined by different class rules and has to comply with International Maritime Organization (IMO) regulations, such as for example the “International Convention for the Safety of Life at Sea (SOLAS)” and “The International Code for The Construction and Equipment of Ships Carrying Liquefied Gases In Bulk (IGC Code)”. These regulations classify the “Inert Gas System” and the “Instrument Air System” as different/independent classes of systems, with their own separate requirements for redundancy and compressors. Therefore, production of inert gas (typically consisting predominantly of nitrogen) and instrument air onboard marine vessels are typically performed using two separate systems, with both systems requiring 100% redundancy. Both systems typically use air compressor(s) to provide compressed air for the production of either nitrogen or instrument air. With two separate systems, four air compressors (one main and one backup for each system), two nitrogen generators for production of inert gas (one main and one backup) and two dryers for production of instrument air (one main and one backup) are required in total in order to comply with relevant class rules for the ship (i.e. in order to ensure that each component of the system has a backup such that if any one component of either system fails the system can continue to operate at 100% capacity). This requires significant capital expenditure and takes up considerable space onboard the vessel.

U.S. Pat. No. 8,317,899 describes a shipboard system for providing dry, oil-free utility air and inert gas for use on a marine vessel. A compressor converts ambient air into a pressurized air stream. The air stream is cooled by heat exchange with sea water in the vicinity of the vessel. The air stream is then dried in a dehydration membrane module, and some of the product of the dehydration module is taken for use as utility air. The remainder of the dried air is passed through an air separation module which includes a polymeric membrane. The product of the air separation module includes a nitrogen-enriched gas which is used as an inert gas on the vessel. The compressor is the only mechanically moving component of the system.

The system described in U.S. Pat. No. 8,317,899 therefore combines the membrane air dryer that is used to generate instrument air and nitrogen generator (separator) that is used to generate inert gas into a single system, thereby avoiding the need for separate air compressors for each of the air dryer and nitrogen generator. However, U.S. Pat. No. 8,317,899 does not describe how the redundancy requirements under the relevant IMO regulations are to be addressed.

### BRIEF SUMMARY

Disclosed herein are methods and systems for use onboard a marine vessel or platform (such as onboard a ship or offshore installation) for producing utility air (such as instrument air or working air) and inert gas onboard the vessel or platform. The methods and systems dry compressed air to produce dry air for use as utility air, and separate compressed air to produce a nitrogen enriched product for use as an inert gas. The invention combines these functions into one combined method and system, reducing the equipment required whilst still fulfilling the redundancy requirements for each application. The overall capital cost, weight and footprint of the system is thereby reduced. By reducing the weight and footprint of the system the overall CO₂ emissions of the marine vessel may also be reduced. In particular, a smaller overall footprint will enable ship- and platform-designers to allocate less space, thus saving steel, weight and so reducing CO₂ emissions.

Several preferred aspects of the systems and methods according to the present invention are outlined below.

Aspect 1: A system for use onboard a marine vessel or platform for producing inert gas and utility air onboard the vessel or platform, the system comprising:
a plurality of nitrogen generators comprising a first nitrogen generator for separating nitrogen from air to produce an inert gas comprising nitrogen and a second nitrogen generator for separating nitrogen from air to produce an inert gas comprising nitrogen;
a plurality of air dryers comprising a first air dryer for generating dry utility air and a second air dryer for generating dry utility air;
a plurality of sources of compressed air comprising a first source of compressed air and a second source of compressed air, the first source of compressed air being connected in fluid flow communication with each of the plurality of nitrogen generators and each of the plurality of air dryers, and the second source of compressed air being connected in fluid flow communication with each of the plurality of nitrogen generators and each of the plurality of dryers; and
flow control means operable to selectively prevent or allow fluid flow between the first source of compressed air and each of the plurality of nitrogen generators and plurality of air dryers, and operable to selectively prevent or allow fluid flow between the second source of compressed air and each of the plurality of nitrogen generators and plurality of air dryers;
wherein the system is configured such that during operation of the system at any one time one of the plurality of nitrogen generators is in use and one of the plurality of nitrogen generators is not in use and one of the plurality of air dryers is in use and one of the plurality of air dryers is not use, the flow control means operating to direct flow of compressed air to whichever of said nitrogen generators is in use and whichever of said air dryers is in use.

Aspect 2: A system according to Aspect 1, wherein the first source of compressed air comprises a first air compressor, and the second source of compressed air comprises a second air compressor.

Aspect 3: A system according to Aspect 2, wherein each of the first air compressor and second air compressor has the capacity to supply sufficient compressed air to simultaneously meet the demands of both the nitrogen generator that is in use and the air dryer that is in use when both said nitrogen generator and said air dryer are operating at maximum capacity.

Aspect 4: A system according to any one of Aspects 1 to 3, wherein the system is further configured such that during operation of the system at any one time one of the plurality of sources of compressed air is in use and one of the plurality of sources of compressed air is not in use, with the flow control means operating to direct the flow of compressed air from whichever of said sources of compressed air is in use to whichever of the nitrogen generators is in use and whichever of the air dryers is in use.

Aspect 5: A system according to Aspect 1, wherein:
the plurality of sources of compressed air further comprise a third source of compressed air in fluid flow communication with each of the plurality of nitrogen generators and each of the plurality of air dryers; and
the flow control means is further operable to selectively prevent or allow fluid flow between the third source of compressed air and each of the plurality of nitrogen generators and plurality of air dryers.

Aspect 6: A system according to Aspect 5, wherein the first source of compressed air comprises a first air compressor, the second source of compressed air comprises a second air compressor, and the third source of compressed air comprises a third air compressor.

Aspect 7: A system according to Aspect 6, wherein the first air compressor, second air compressor and third air compressor each has the capacity to supply sufficient compressed air to meet the demands of either the nitrogen generator that is in use or the air dryer that is in use when said nitrogen generator or air dryer is operating at maximum capacity.

Aspect 8: A system according to any one of Aspects 5 to 7, wherein the system is further configured such that during operation of the system at any one time two of the plurality of sources of compressed air are in use and one of the plurality of sources of compressed air is not in use, with the flow control means operating to direct the flow of compressed air from whichever of said sources of compressed air are in use to whichever of the nitrogen generators is in use and whichever of the air dryers is in use.

Aspect 9: A system according to any one of Aspects 1 to 8, wherein:
the first nitrogen generator and first air dryer are components of a first combined generator capable of receiving and processing compressed air to produce either or both an inert gas comprising nitrogen from the first nitrogen generator and dry utility air from the first air dryer; and
the second nitrogen generator and second air dryer are components of a second combined generator capable of receiving and processing compressed air to produce either or both an inert gas comprising nitrogen from the second nitrogen generator and dry utility air from the second air dryer.

Aspect 10: A system according to any one of Aspects 1 to 8, wherein:
the plurality of nitrogen generators further comprise a third nitrogen generator for separating nitrogen from air to produce an inert gas comprising nitrogen, and the plurality of air dryers further comprise a third air dryer for generating dry utility air; and
the system is further configured such that during operation of the system at any one time one of the plurality of nitrogen generators is in use and two of the plurality of nitrogen generators are not in use and one of the plurality of air dryers is in use and two of the plurality of air dryers are not use, the flow control means operating to direct the flow of compressed air to whichever of the nitrogen generators is in use and whichever of the air dryers is in use.

Aspect 11: A system according to Aspect 10, wherein:
the first nitrogen generator and first air dryer are components of a first combined generator capable of receiving and processing compressed air to produce either an inert gas comprising nitrogen from the first nitrogen generator or dry utility air from the first air dryer;
the second nitrogen generator and second air dryer are components of a second combined generator capable of receiving and processing compressed air to produce either an inert gas comprising nitrogen from the second nitrogen generator or dry utility air from the second air dryer; and
the third nitrogen generator and third air dryer are components of a third combined generator capable of receiving and processing compressed air to produce either an inert gas comprising nitrogen from the third nitrogen generator or dry utility air from the third air dryer.

Aspect 12: A marine vessel or platform including a system according to any one of Aspects 1 to 11.

Aspect 13: A method of producing inert gas and utility air onboard a marine vessel or platform, wherein the method uses a system comprising:
a plurality of nitrogen generators comprising a first nitrogen generator for separating nitrogen from air to produce an inert gas comprising nitrogen and a second nitrogen generator for separating nitrogen from air to produce an inert gas comprising nitrogen;
a plurality of air dryers comprising a first air dryer for generating dry utility air and a second air dryer for generating dry utility air;
a plurality of sources of compressed air comprising a first source of compressed air and a second source of compressed air, the first source of compressed air being connected in fluid flow communication with each of the plurality of nitrogen generators and each of the plurality of air dryers and the second source of compressed air being connected in fluid flow communication with each of the plurality of nitrogen generators and each of the plurality of air dryers; and
flow control means operable to selectively prevent or allow fluid flow between the first source of compressed air and each of the plurality of generators and plurality of air dryers, and operable to selectively prevent or allow fluid flow between the second source of compressed air and each of the plurality of nitrogen generators and plurality of air dryers; and
wherein at any one time one of the plurality of nitrogen generators is in a use and one of the plurality of nitrogen generators is not in use and one of the plurality of air dryers is in use and one of the plurality of air dryers is not in use, the method comprising using the flow control means to direct flow of compressed air to whichever of said nitrogen generators is in use and whichever of said air dryers is in use to produce inert gas from said nitrogen generator and utility air from said air dryer.

Aspect 14: A method according to Aspect 13, wherein at any one time one of the plurality of sources of compressed air is in use and one of the plurality of sources of compressed air is not in use, with the flow control means being used to direct the flow of compressed air from whichever of said sources of compressed air is in use to whichever of the nitrogen generators is in use and whichever of the air dryers is in use.

Aspect 15: A method according to Aspect 14, wherein for an initial period of time the first source of compressed air is used to provide compressed air, and then during a subsequent period of time the second source of compressed air is used to provide compressed air.

Aspect 16: A method according to Aspect 13, wherein:
the plurality of sources of compressed air further comprise a third source of compressed air in fluid flow communication with each of the plurality of nitrogen generators and each of the plurality of air dryers; and
the flow control means is further operable to selectively prevent or allow fluid flow between the third source of compressed air and each of the plurality of nitrogen generators and plurality of air dryers; and
at any one time two of the plurality of sources of compressed air are in use and one of the plurality of sources of compressed air is not in use, with the flow control means being used to direct the flow of compressed air from whichever of said sources of compressed air are in use to whichever of the nitrogen generators is in use and whichever of the air dryers is in use.

Aspect 17: A method according to Aspect 16, wherein for an initial period of time the first and third sources of compressed air are used to provide compressed air, and then during a subsequent period of time the second and third sources of compressed air are used to provide compressed air.

Aspect 18: A method according to any one of Aspects 13 to 17, wherein for an initial period of time inert gas is produced using the first nitrogen generator and utility air is produced using the first air dryer, and then the nitrogen generator and/or the air dryer that is in use is switched such that during a subsequent period of time inert gas is produced using the first nitrogen generator and utility air is produced using the second air dryer, or inert gas is produced using the second nitrogen generator and utility air is produced using the first air dryer, or inert gas is produced using the second nitrogen generator and utility air is produced using the second air dryer.

Aspect 19: A method according to any one of Aspects13 to 17, wherein:
the plurality of nitrogen generators further comprise a third nitrogen generator for separating nitrogen from air to produce an inert gas comprising nitrogen, and the plurality of air dryers further comprise a third air dryer for generating dry utility air; and
wherein at any one time one of the plurality of nitrogen generators is in use and two of the plurality of nitrogen generators are not in use and one of the plurality of air dryers is in use and two of the plurality of air dryers are not in use, the method comprising using the flow control means to direct flow of compressed air to whichever of the nitrogen generators is in use and whichever of the air dryers is in use to produce inert gas from said nitrogen generator and utility air from said air dryer.

Aspect 20: A method according to Aspect 19, wherein for an initial period of time inert gas is produced using the first nitrogen generator and utility air is produced using the second air dryer, and then the nitrogen generator or the air dryer that is in use is switched such that during a subsequent period of time inert gas is produced using the third nitrogen generator and utility air is produced using the second air dryer, or inert gas is produced using the first nitrogen generator and utility air is produced using the third air dryer.

### BRIEF DESCRIPTION OF THE DRAWINGS

FIG. 1 is a schematic depicting a conventional method and associated systems, not in accordance with the present invention, for producing inert gas and utility air for use onboard a marine vessel or platform.

FIG. 2 is a schematic depicting a system and method, in accordance with one embodiment the present invention, for producing inert gas and utility air for use onboard a marine vessel or platform.

FIG. 3 is a schematic depicting a system and method, in accordance with another embodiment the present invention, for producing inert gas and utility air for use onboard a marine vessel or platform.

FIG. 4 is a schematic depicting a system and method, in accordance with a further embodiment the present invention, for producing inert gas and utility air for use onboard a marine vessel or platform.

FIG. 5 is a schematic depicting a system and method, in accordance with a further embodiment the present invention, for producing inert gas and utility air for use onboard a marine vessel or platform.

### DETAILED DESCRIPTION

As used herein and unless otherwise indicated, the articles “a” and “an” mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

Where letters are used herein to identify recited steps of a method (e.g. (a), (b), and (c)), these letters are used solely to aid in referring to the method steps and are not intended to indicate a specific order in which claimed steps are performed, unless and only to the extent that such order is specifically recited.

Where used herein to identify recited features of a method or system, the terms “first”, “second”, “third” and so on, are used solely to aid in referring to and distinguishing between the features in question and are not intended to indicate any specific order of the features, unless and only to the extent that such order is specifically recited.

As used herein, the term “inert gas” refers to a gas that does not readily undergo chemical reactions with other substances with which it is to be used or come into contact. Typically, an inert gas suitable for use onboard a marine vessel or platform may comprise one or more gases selected from nitrogen, carbon dioxide, helium, neon, argon, krypton, xenon, and radon. So as to avoid causing chemical reactions such as oxidation, the inert gas should be free or essentially free of oxygen (i.e. oxygen, if present, should be present in at most de minimis levels that will not cause chemical reactions to occur to any meaningful degree). So as to avoid causing chemical reactions such as hydrolysis, the inert gas should typically also be free or essentially free of moisture (i.e. moisture, if present, should be present in at most de minimis levels that will not cause chemical reactions to occur to any meaningful degree). Inert gas may be used onboard a vessel or platform for a variety of tasks, such as for example as a blanketing gas or purging gas in cargo or fuel tanks or bunkers.

In the present invention, nitrogen generators are used to produce an inert gas comprising, or consisting or consisting essentially of, nitrogen. The nitrogen generators function by separating nitrogen from air in order to produce a product stream that is enriched in nitrogen and depleted in oxygen relative to the air steam fed to the nitrogen generator (which product stream forms the inert gas). Unless the air stream fed to the nitrogen generator has already been pre-treated to remove moisture, the nitrogen generator should typically also function to remove moisture from the air in order to produce a product stream that is also depleted in water relative to the air steam fed to the nitrogen generator. Various types of nitrogen generator suitable for carrying out such operations are known and can be used in accordance with the present invention. For example, the nitrogen generator may comprise one or more membrane separation units (typically utilizing one or more membranes that are more permeable to oxygen than nitrogen) and/or one or more pressure swing adsorption units (typically utilizing adsorbent that preferentially adsorbs oxygen over nitrogen) in order to separate a nitrogen-enriched product stream from a compressed air feed stream. In order to obtain a dry nitrogen-enriched product stream, the same membrane separation units and/or pressure swing adsorption units may also be used to remove moisture from the compressed air feed stream (utilizing for example and as appropriate also one or more membranes that are more permeable to water than nitrogen or an adsorbent that preferentially adsorbs water over nitrogen), and/or the nitrogen generator may include an air dryer upstream of said membrane separation units and and/or pressure swing adsorption units (which air dryer may take any of the forms discussed below with regard to the air dryers used for producing utility air).

As used herein, the term “utility air” refers to air that is for use onboard the marine vessel or platform by systems and processes other than the system and processes that produced the utility air itself (i.e., in the case of the present application, it refers to air that is for use onboard the marine vessel or platform by systems other than the system for producing inert gas and utility air). Utility air must suitable for use in the systems and processes in which it is intended to be used, and typically must therefore constitute compressed dry air. As used herein, the term “dry air” refers to air that is free or essentially free of moisture (i.e. any moisture that is present should be present in at most de minimis levels that will not interfere with the purposes for which the air is to be used). Preferably, the dry air used as utility air has a dew point of equal to or less than −20° C. at atmospheric pressure, more preferably a dew point of equal to or less than −30° C. at atmospheric pressure, and most preferably a dew point of equal to or less than −40° C. at atmospheric pressure. The utility air may, for example, be instrument air. Instrument air must be free or essentially free of moisture (and oil and particulates) in order to avoid plugging air lines and fouling instruments, for example. Such air may for example be used onboard a vessel or platform for various types of pneumatic equipment, valves & electrical controls.

In the present invention, air dryers are used to produce utility air. Various types of air dryers are known and can be used in accordance with the present invention for drying a compressed air feed stream to produce utility air. For example, the air dryer may comprise one or more membrane separation units (utilizing one or more membranes that are more permeable to water than other components of air), one or more adsorption units (such as one or more pressure and/or temperature swing adsorption units utilizing adsorbent that preferentially adsorbs water over the other components of air) and/or one or more refrigeration units (utilizing any type of refrigerant and refrigeration cycle suitable for cooling the compressed air feed stream down to the temperatures necessary to condense out and remove water vapor from said air stream).

As used herein, reference to a product stream from a process or system being “enriched” in a particular gas or component means that the stream has a higher mole % of said particular gas or component than the feed stream to the process or system, and reference to a product stream from a process or system being “depleted” in a particular gas or component means that the stream has a lower mole % of said particular gas or component than the feed stream to the process or system. Thus, where for example a feed stream comprising a first gas and a second gas is being separated via a separation process to provide a product stream depleted in the first gas and enriched in the second gas, said product stream has a lower mole % of the first gas and a higher mole % of the second gas than the feed stream.

As used herein, the term “source of compressed air” refers to (and thus encompasses) both devices that can generate compressed air (such as compressors), devices that can store and dispense compressed air (such as storage tanks and reservoirs) and combinations thereof. In preferred embodiments, however, the sources of compressed air comprise or consist of compressors. Various types of compressors suitable for compressing air are known and can be used in accordance with the present invention. For example, positive displacement compressors (e.g. reciprocating or rotary) or dynamic displacement compressors (e.g. axial or centrifugal) can be used. Each compressor may consist of a single compression stage or may comprise two or more compression stages arranged in series and/or parallel and housed in the same or separate housings. Each compressor may also be provided with aftercoolers for cooling the air stream after compression and/or (in the case of compressors comprising two or more stages arranged in series) intercoolers for cooling the air stream between compression stages.

As used herein, the term “fluid flow communication” refers to the nature of connectivity between two or more components that enables liquids, vapors, and/or two-phase mixtures to be transported between the components in a controlled fashion (i.e., without leakage) either directly or indirectly. Coupling two or more components such that they are in fluid flow communication with each other can involve any suitable method known in the art, such as with the use of welds, flanged conduits, gaskets, and bolts. Two or more components may also be coupled together via other components of the system that may separate them, for example, valves, gates, or other devices that may selectively prevent, allow, restrict or direct fluid flow. As used herein, the term “conduit” refers to one or more structures through which fluids can be transported between two or more components of a system. For example, conduits can include pipes, ducts, passageways, and combinations thereof that transport liquids, vapors, and/or gases.

As used herein, the term “flow control means” refers to valves, gates, or other devices that are operable to selectively prevent, allow, restrict or direct fluid flow (including devices that are operable to carry out two or more or all of these functions). Such flow control means may be operated manually. Alternatively, they may be controlled via suitable controllers (such as for example programmable logic controllers), in which case operation of the flow control means may be partially or fully automated (with the controllers also being coupled to suitable sensors, monitors or detectors and functioning to operate the flow control means when certain events are detected to have occurred).

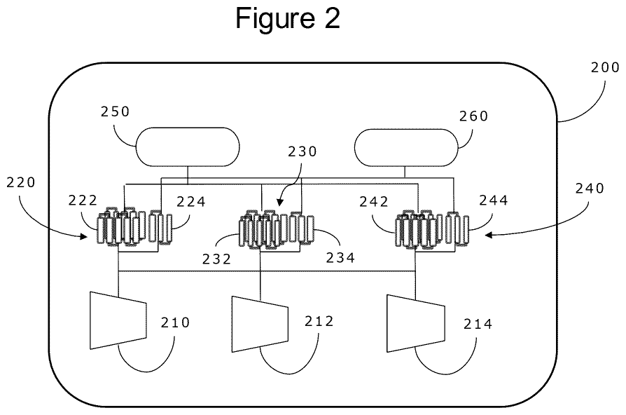

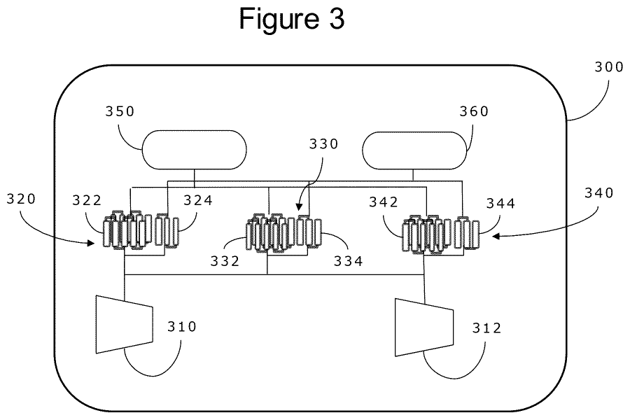

Solely by way of example, various exemplary embodiments of the invention will now be described with reference to FIGS. 2 to 5. In these Figures, where a feature is common to more than one Figure that feature has been assigned the same reference numeral differing by a factor of 100. Thus, for example, first nitrogen generator 222 in FIG. 2 corresponds to first nitrogen generator 322 in FIG. 3. Unless a feature is specifically described as being different from other embodiments in which it is shown in the drawings, that feature can be assumed to have the same structure and function as the corresponding feature in the embodiment in which it is described. Moreover, if that feature does not have a different structure or function in a subsequently-described embodiment, it may not be specifically referred to in the specification.

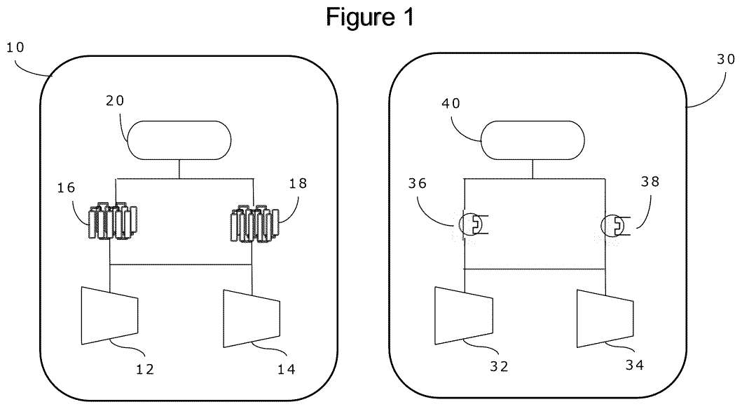

Referring first to FIG. 1, a schematic of a conventional method and associated systems for producing inert gas and utility air for use onboard a marine vessel or platform, not in accordance with the present invention, is shown. In this conventional arrangement production of inert gas and utility air is performed using two separate systems (10, 30), one for producing inert gas and the other for producing utility air.

The system for producing inert gas (10) comprises a first air compressor (12), second air compressor (14), first nitrogen generator (16), and second nitrogen generator (18). In the illustrated system, the first nitrogen generator (16), and second nitrogen generator (18) are each membrane separation units that utilize one or more membranes that are more permeable to oxygen than nitrogen. The first air compressor (12) and second air compressor (14) are each connected in fluid flow communication with each of the first nitrogen generator (16) and second nitrogen generator (18) via a suitable arrangement of conduits including flow control means (in the form of valves, gates or other such devices) that are operable to selectively prevent or allow fluid flow between each of the first and second air compressors (12, 14) and each of the first and second nitrogen generators (16, 18). During operation, only one of the first and second air compressors (12, 14) and only one of the first and second nitrogen generators (16, 18) is used at any one time. The compressed air stream that is generated by whichever of said compressors (12, 14) is in use is directed via the flow control means to whichever of said nitrogen generators (16, 18) is in use. The nitrogen generator that is in use then separates nitrogen from said compressed air stream to produce a nitrogen enriched product stream that is supplied as inert gas to one or more devices (20) onboard the vessel or platform that require a supply of inert gas. The compressor and nitrogen generator that are not in use are present as backups for the compressor and nitrogen generator that are in use, such that in the event of unexpected or planned shutdown (such as for example in the event of malfunction or required maintenance) of either or both of the compressor and nitrogen generator that were in use the production of inert gas at 100% capacity can be maintained by switching to the use of the other compressor and/or nitrogen generator. In this way, the system for producing inert gas (10) is provided with 100% redundancy.

The system for producing utility air (30) comprises a first air compressor (32), second air compressor (34), first air dryer (36), and second air dryer (38). In the illustrated system, the first air dryer (36), and second air dryer (38) are each refrigeration units for cooling, condensing out and removing water vapor from a compressed air stream. The first air compressor (32) and second air compressor (34) are each connected in fluid flow communication with each of the first air dryer (36), and second air dryer (38) via a suitable arrangement of conduits including flow control means (in the form of valves, gates or other such devices) that are operable to selectively prevent or allow fluid flow between each of the first and second air compressors (32, 34) and each of the first and second air dryers (36, 38). During operation, only one of the first and second air compressors (32, 34) and only one of the first and second air dryers (36, 38) is used at any one time. The compressed air stream that is generated by whichever of said compressors (32, 34) is in use is directed via the flow control means to whichever of said air dryers (36, 38) is in use. The air dryer that is in use then removes moisture from the compressed air stream in order to generate a dry air stream that is supplied as utility air to one or more instruments or other devices (40) onboard the vessel or platform that require a supply of utility air. The compressor and air dryer that are not in use are present as backups for the compressor and air dryer that are in use, such that in the event of unexpected or planned shutdown (such as for example in the event of malfunction or required maintenance) of either or both of the compressor and air dryer that were in use the production of utility air at 100% capacity can be maintained by switching to the use of the other compressor and/or air dryer. In this way, the system for producing utility air (30) is provided with 100% redundancy.

The conventional method for producing inert gas and utility air depicted in FIG. 1 is therefore provided with 100% redundancy. However, it requires the onboard presence of four separate air compressors (12, 14, 32, 34), two separate nitrogen generators (16, 18) and two separate air dryers (36, 38), which involves significant capital expenditure and takes up considerable space onboard the vessel.

Turning now to FIG. 2, a schematic depicting a system (200) and method in accordance with a first embodiment the present invention is shown. The system is for use onboard a marine vessel or platform and is operated to produce inert gas and utility air for use onboard the vessel or platform.

The system (200) comprises: a plurality of nitrogen generators comprising a first nitrogen generator (222) for separating nitrogen from air to produce an inert gas comprising nitrogen, a second nitrogen generator (232) for separating nitrogen from air to produce an inert gas comprising nitrogen, and a third nitrogen generator (242) for separating nitrogen from air to produce an inert gas comprising nitrogen; a plurality of nitrogen generators comprising a first air dryer (224) for generating dry utility air, a second air dryer (234) for generating dry utility air, and a third air dryer (244) for generating dry utility air; and a plurality of sources of compressed air comprising a first air compressor (210), a second air compressor (212) and a third air compressor (214). The first air compressor (210), second air compressor (212) and third air compressor (214) are each connected in fluid flow communication with each of the first nitrogen generator (222), second nitrogen generator (232), third nitrogen generator (242), first air dryer (224), second air dryer (234) and third air dryer (244) via a suitable arrangement of conduits including flow control means (in the form of valves, gates or any other suitable devices) that are operable to selectively prevent or allow fluid flow between each of the first, second and third air compressor (210, 212 and 214) and each of the first nitrogen generator (222), second nitrogen generator (232), third nitrogen generator (242), first air dryer (224), second air dryer (234) and third air dryer (244).

In FIG. 2 the connection between each of the air compressors (210, 212 and 214) and each of the nitrogen generators (222, 232, 242) and air dryers (224, 234, 244) is, for the sake of simplicity, depicted schematically via a single line. However, as the skilled person will appreciate, in practice there may be multiple conduits and manifolds arranged in parallel, each equipped with appropriate flow control devices (e.g. valves, gates or the like), so as to allow compressed air from any one of the compressors to be directed to any one of the nitrogen generators or air dryers without this interfering with compressed air from any other one of the compressors being directed to any other one of the nitrogen generators or air dryers.

In the embodiment depicted in FIG. 2, the first air compressor (210), second air compressor (212) and third air compressor (214) each has the capacity to supply sufficient compressed air to meet the demands of any one of the first nitrogen generator (222), second nitrogen generator (232), third nitrogen generator (242), first air dryer (224), second air dryer (234) and third air dryer (244) when said nitrogen generator or air dryer is operating at maximum capacity.

Each of the first air compressor (210), second air compressor (212) and third air compressor (214) can be a compressor of any type and can consist of a single compression stage or can comprise two or more compression stages arranged in series and/or parallel. In preferred embodiments, each of the compressors is a compressor of the rotary screw type, such as an oil-lubricated screw compressor. Each compressor can contain an oil separator tank to separate lubricating oil from compressed air and a heat exchanger (water or air as cooling fluid) to cool the warm oil. Each compressor can be equipped with one or more aftercoolers and/or intercoolers (again using water or air as cooling fluid for said heat exchanger) for cooling the compressed air, together with a water separator to separate out condensed water from compressed air.

Each of the first air compressor (210), second air compressor (212) and third air compressor (214) compresses ambient air from atmospheric pressure to, preferably, a pressure of 6-16 barg. The discharge pressure of each compressor can for example be regulated using a throttling inlet suction valve, or each compressor can for example operate at full load and start/stop based on predefined pressures in a downstream air receiver. Each compressor can alternatively have frequency control to regulate the air flow rate or outlet pressure.

Preferably, each of the compressors is of an identical type and design and operates in an identical manner.

In the embodiment depicted in FIG. 2, the first nitrogen generator (222) and first air dryer (224) are components of a first combined generator (220) capable of receiving a compressed air stream from one of the compressors (210, 212, 214) and directing this to the first nitrogen generator (222) or first air dryer (224) in order to produce either an inert gas comprising nitrogen from the first nitrogen generator (222) or dry utility air from the first air dryer (224). Likewise the second nitrogen generator (232) and second air dryer (234) are components of a second combined generator (230) capable of receiving a compressed air stream from one of the compressors (210, 212, 214) and directing this to the second nitrogen generator (232) or second air dryer (234) in order to produce either an inert gas comprising nitrogen from the second nitrogen generator (232) or dry utility air from the second air dryer (234); and the third nitrogen generator (242) and third air dryer (244) are components of a third combined generator (240) capable of receiving a compressed air stream from one of the compressors and directing this to the third nitrogen generator (242) or third air dryer (244) in order to produce either an inert gas comprising nitrogen from the third nitrogen generator (242) or dry utility air from the third air dryer (244).

The first, second and third nitrogen generators (222, 232, 234) may be devices of any type suitable for separating nitrogen from a compressed air stream in order to produce a product stream that is enriched in nitrogen and depleted in oxygen to a sufficient degree for use as an inert gas. For example, each nitrogen generator may comprise one or more membrane separation units (as illustrated in FIG. 2 for purely exemplary purposes) utilizing one or more membranes that are more permeable to oxygen than nitrogen in order to separate the compressed air stream (feed stream) into a nitrogen-enriched stream retentate stream (the inert gas product stream) and an oxygen-enriched permeate stream (that can be rejected as waste or used for any other purpose). Alternatively or additionally, each nitrogen generator may comprise one or more pressure swing adsorption (PSA) units utilizing one or more beds of adsorbent that preferentially adsorb oxygen over nitrogen (such as for example where the oxygen is adsorbed to active sites on a molecular sieve adsorbent material) in order to produce a nitrogen-enriched product stream (the inert gas product stream), with the beds of adsorbent being regenerated when necessary by passing a purge gas through the bed at reduced pressure in order to desorb the adsorbed oxygen from the bed.

The nitrogen generators can include one or more coalescing or particle filters to separate remaining oil or particles from the compressed air, and/or one or more electrical heaters or heat exchanger to heat the compressed air above saturation temperature, positioned upstream of the membrane separation unit(s), PSA unit(s) or other device(s) used to separate nitrogen from the compressed air stream. An air dryer of any suitable type (such as for example a carbon bed) may be positioned upstream of the membrane separation unit(s), PSA unit(s) or other device(s) used to separate nitrogen from the compressed air stream, in order to dry the compressed air stream prior to said steam being fed to the to the membrane separation unit(s), PSA unit(s) or other such device(s). Alternatively or additionally, the device(s) used for separating nitrogen from the compressed air stream may also function to separate moisture from the compressed air stream in order to provide a dry nitrogen-enriched product stream. For example, the nitrogen generator may comprise one or more membrane separation units that also utilize one or more membranes that are more permeable to water than nitrogen, and/or one or more pressure swing adsorption (PSA) units utilizing one or more beds of adsorbent that preferentially adsorb water over nitrogen. Control over the flow rate and nitrogen purity (as for example measured in terms of oxygen content) of the nitrogen product stream produced by each nitrogen generator can for example be effected using one or more flow control valves.

Preferably, each of the nitrogen generators is of an identical type and design and operates in an identical manner.

The first, second and third air dryers (224, 234, 244) may be devices of any type suitable for drying a compressed air feed stream to produce utility air. For example, each air dryer may comprise one or more membrane separation units (as illustrated in FIG. 2 for purely exemplary purposes) utilizing one or more membranes that are more permeable to water than other components of air in order to produce a retentate (product) stream of dried compressed air. Alternatively or additionally, each air dryer may comprise one or more pressure swing adsorption (PSA) and/or temperature swing adsorption (TSA) units utilizing one or more beds of adsorbent that preferentially adsorb water over other components of air in order to produce a dried compressed air product stream, with the beds of adsorbent being regenerated when necessary by passing a purge gas through the bed at reduced pressure and/or elevated temperature in order to desorb water from the bed. Alternatively or additionally, each air dryer may comprise one or more refrigeration units (utilizing any suitable type of refrigerant and refrigeration cycle suitable) with associated gas/liquid separators that can be used to cool down the compressed air feed stream and condense out and remove water vapor therefrom.

The air dryers can include one or more coalescing or particle filters to separate remaining oil or particles from the compressed air. The air dryers can also include one or more particle filters downstream of the drying equipment to separate any particles originated from the drying process from the dried compressed air.

Preferably, each of the air dryers is of an identical type and design and operates in an identical manner.

The system (200) and method of FIG. 2 is configured and operated such that only two of the first, second and third air compressors (210, 212, 214), only one of the first, second and third nitrogen generators (222, 232, 234), and only one of the first, second and third air dryers (224, 234, 244) are in use at any one time. The compressed air stream that is generated by one of the compressors that is in use is directed via the flow control means to whichever of the nitrogen generators is in use, with said nitrogen generator then separating nitrogen from said compressed air stream to produce a nitrogen enriched product stream that is supplied as inert gas to one or more devices (250) onboard the vessel or platform that require a supply of inert gas. The compressed air stream that is generated by the other of the compressors that is in use is directed via the flow control means to whichever of the air dryers is in use, with said air dryer then removing moisture from said compressed air stream in order to generate a dry air stream that is supplied as utility air to one or more instruments or other devices (260) onboard the vessel or platform that require a supply of utility air.

Since in the embodiment of FIG. 2 each of the combined generators can receive and process compressed air using either its nitrogen generator to produce inert gas or its air dryer to produce utility air (but cannot use both to produce inert gas and utility air simultaneously), the system (200) and method of FIG. 2 can operate in any one of the following permutations set out below in Table 1. In this Table, each row represents one of the possible operating permutations, with the first column indicating the compressors that are in use, the second column indicating the nitrogen generator that is in use, and the third column indicating the air dryer that is in use (“C1” representing the first air compressor, “C2” representing the second air compressor, “C3” representing the third air compressor, “N1” representing the first nitrogen generator, “N2” representing the second nitrogen generator, “N3” representing the third nitrogen generator, “D1” representing the first air dryer, “D2” representing the second air dryer and “D3” representing the third air dryer).

TABLE 1

| Compressor | Nitrogen Generator | Dryer |
|---|---|---|
| C1 + C2 | N1 | D2 |
| C1 + C2 | N1 | D3 |
| C1 + C2 | N2 | D1 |
| C1 + C2 | N2 | D3 |
| C1 + C2 | N3 | D1 |
| C1 + C2 | N3 | D2 |
| C2 + C3 | N1 | D2 |
| C2 + C3 | N1 | D3 |
| C2 + C3 | N2 | D1 |
| C2 + C3 | N2 | D3 |
| C2 + C3 | N3 | D1 |
| C2 + C3 | N3 | D2 |
| C3 + C1 | N1 | D2 |
| C3 + C1 | N1 | D3 |
| C3 + C1 | N2 | D1 |
| C3 + C1 | N2 | D3 |
| C3 + C1 | N3 | D1 |
| C3 + C1 | N3 | D2 |

As is apparent from the above Table, at any one time one of the air compressors and one of the combined generators (and thus the nitrogen generator and air dryer of said combined generator) are not in use and are therefore available as backups for the devices that are in use. Accordingly, in the event of an unexpected or planned shutdown (such as for example in the event of malfunction or required maintenance) of one of the compressors that is in use and/or one of the combined generators (i.e. one of the nitrogen generators or air dryers) that is in use the production of inert gas and utility air at 100% capacity can be maintained by switching to the use of the compressor and/or the combined generator (and its nitrogen generator or air dryer) that was not in use.

The system and method of FIG. 2 is therefore still provided with 100% redundancy as required under IMO regulations, but it achieves this with using one less air compressor than the conventional method and systems depicted in FIG. 1, and therefore significantly reduces both the required capital expenditure and footprint of the system (i.e. the amount of space required by the system onboard the vessel or platform).

Turning now to FIG. 3, a schematic depicting a system (300) and method in accordance with a second embodiment the present invention is shown.

The system (300) and method of FIG. 3 differs from that depicted in FIG. 2 in that the system and method of FIG. 3 uses only two air compressors, namely first air compressor (310) and second air compressor (320), instead of three air compressors as used in FIG. 2.

The first air compressor (310) and second air compressor (312) are again each connected in fluid flow communication with each of the first nitrogen generator (322), second nitrogen generator (332), third nitrogen generator (342), first air dryer (324), second air dryer (334) and third air dryer (344) via a suitable arrangement of conduits including flow control means that are operable to selectively prevent or allow fluid flow between each of the first and second air compressor (310 and 312) and each of the first nitrogen generator (322), second nitrogen generator (332), third nitrogen generator (342), first air dryer (324), second air dryer (334) and third air dryer (344) (with the connection between each air compressor and each of the nitrogen generators and air dryers again being depicted schematically via a single line, for the sake of simplicity).

However, in the embodiment depicted in FIG. 3 the first air compressor (310) and second air compressor (312) each has the capacity to supply sufficient compressed air to simultaneously meet the demands of both one of the nitrogen generators (322, 332, 342) and one the air dryers (324, 334, 344) when both said nitrogen generator and said air dryer are operating at maximum capacity. The system (300) and method is configured and operated such that only one of the first and second air compressors (310, 312), only one of the first, second and third nitrogen generators (322, 332, 334), and only one of the first, second and third air dryers (324, 334, 344) are in use at any one time. The compressed air that is generated by the compressor that is in use is divided and directed via the flow control means to whichever of the nitrogen generators is in use and whichever of the air dryers is in use, with said nitrogen generator separating nitrogen from the compressed air stream received by it in order to produce a nitrogen enriched product stream that is supplied as inert gas to one or more devices (350) onboard the vessel or platform that require a supply of inert gas, and with said air dryer removing moisture from the compressed air stream received by it in order to generate a dry air stream that is supplied as utility air to one or more instruments or other devices (360) onboard the vessel or platform that require a supply of utility air.

This means that the system (300) and method of FIG. 3 can operate in any one of the following permutations set out below in Table 2. In this Table, each row again represents one of the possible operating permutations, with the first column indicating the compressor that is in use, the second column indicating the nitrogen generator that is in use, and the third column indicating the air dryer that is in use (and with “C1”, “C2”, “N1”, “N2”, “N3”, “D1”, “D2” and “D3” having the same meanings as in Table 1).

TABLE 2

| Compressor | Nitrogen Generator | Dryer |
|---|---|---|
| C1 | N1 | D2 |
| C1 | N1 | D3 |
| C1 | N2 | D1 |
| C1 | N2 | D3 |
| C1 | N3 | D1 |
| C1 | N3 | D2 |
| C2 | N1 | D2 |
| C2 | N1 | D3 |
| C2 | N2 | D1 |
| C2 | N2 | D3 |
| C2 | N3 | D1 |
| C2 | N3 | D2 |

As will again be apparent from the above Table, at any one time one of the air compressors and one of the combined generators (and thus the nitrogen generator and air dryer of said combined generator) are not in use and are therefore available as backups for the devices that are in use. Accordingly, in the event of an unexpected or planned shutdown (such as for example in the event of malfunction or required maintenance) of the compressor that is in use and/or one of the combined generators (i.e. one of the nitrogen generators or air dryers) that is in use the production of inert gas and utility air at 100% capacity can be maintained by switching to the use of the compressor and/or the combined generator (and its nitrogen generator or air dryer) that was not in use.

The system and method of FIG. 3 therefore provides similar benefits and advantages to those provided by the system and method of FIG. 2 (i.e. it maintains 100% redundancy while reducing both the required capital expenditure and footprint of the system). In comparison to the system and method of FIG. 2, the system and method of FIG. 3 requires the use and presence of one fewer compressor, although the compressors that are used have to be of a larger capacity.

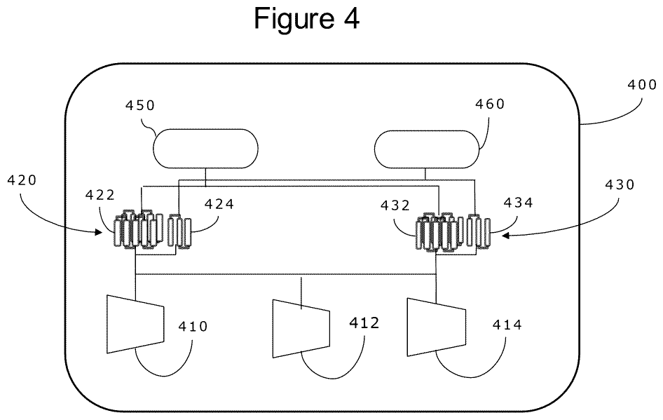

Turning now to FIG. 4, a schematic depicting a system (400) and method in accordance with a third embodiment the present invention is shown.

The system (400) and method of FIG. 4 differs from that depicted in FIG. 2 in that the system and method of FIG. 4 uses only two nitrogen generators, namely first nitrogen generator (422) and second nitrogen generator (432), and only two air dryers, namely first air dryer (424) and second air dryer (434), instead of three nitrogen generators and three air dryers as used in FIG. 2.

In the embodiment depicted in FIG. 4, the first nitrogen generator (422) and first air dryer (424) are again components of a first combined generator (420), and the second nitrogen generator (432) and second air dryer (434) are again components of a second combined generator (430). However, in this embodiment the first combined generator (420) is capable of receiving and processing compressed air to produce either or both an inert gas comprising nitrogen from the first nitrogen generator (422) and dry utility air from the first air dryer (424). Likewise, the second combined generator (430) is capable of receiving and processing compressed air to produce either or both an inert gas comprising nitrogen from the second nitrogen generator (432) and dry utility air from the second air dryer (434). Thus, in this embodiment the first combined generator (420) may receive a compressed air stream from one of the air compressors (410, 412, 414) that is in use in order to produce either inert gas or utility air and the second combined generator (430) may receive a compressed air stream from the other of the air compressors (410, 412, 414) that is in use in order to produce utility air (if the first combined generator is producing inert gas) or inert gas (if the first combined generator is producing utility air); or alternatively one of the combined generators (420, 430) can receive both compressed air streams from both of the air compressors (410, 412, 414) that are in use in order to simultaneously produce both inert gas or utility air.

This means that the system (400) and method of FIG. 4 can operate in any one of the following permutations set out below in Table 3. In this Table, each row again represents one of the possible operating permutations, with the first column indicating the compressors that are in use, the second column indicating the nitrogen generator that is in use, and the third column indicating the air dryer that is in use (and with “C1”, “C2”, “C3”, “N1”, “N2”, “D1” and “D2” having the same meanings as in Table 1).

TABLE 3

| Compressor | Nitrogen Generator | Dryer |
|---|---|---|
| C1 + C2 | N1 | D1 |
| C1 + C2 | N1 | D2 |
| C1 + C2 | N2 | D1 |
| C1 + C2 | N2 | D2 |
| C2 + C3 | N1 | D1 |
| C2 + C3 | N1 | D2 |
| C2 + C3 | N2 | D1 |
| C2 + C3 | N2 | D2 |
| C3 + C1 | N1 | D1 |
| C3 + C1 | N1 | D2 |
| C3 + C1 | N2 | D1 |
| C3 + C1 | N2 | D2 |

As will again be apparent from the above Table, at any one time one of the air compressors, one of the nitrogen generators and one of the air dryers are not in use and are therefore available as backups for the devices that are in use. Accordingly, in the event of an unexpected or planned shutdown (such as for example in the event of malfunction or required maintenance) of one of the compressors that is in use, the nitrogen generator that is in use, and/or the air dryer that is in use the production of inert gas and utility air at 100% capacity can be maintained by switching to the use of the compressor, nitrogen generator and/or air dryer that was not in use.

The system and method of FIG. 4 therefore provides similar benefits and advantages to those provided by the system and method of FIG. 2 (i.e. it maintains 100% redundancy while reducing both the required capital expenditure and footprint of the system). In comparison to the system and method of FIG. 2, the system and method of FIG. 4 requires the use and presence of one fewer combined generator, although the combined generators that are used have to be able to accommodate a greater total throughput of compressed air.

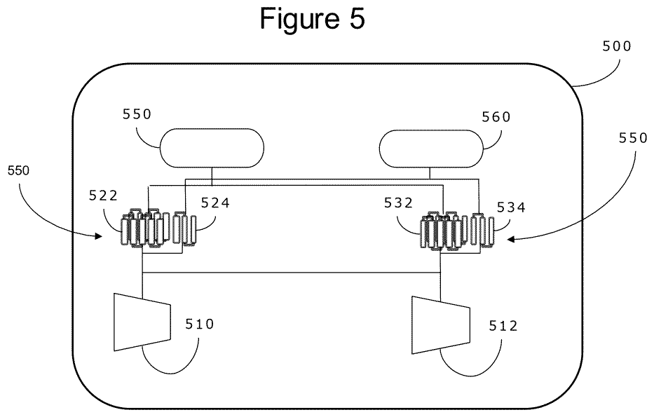

Turning finally to FIG. 5, a schematic depicting a system (500) and method in accordance with a fourth embodiment the present invention is shown.

The system (500) and method of FIG. 5 differs from that depicted in FIG. 3 in the same way that the system and method of FIG. 4 differs from that depicted in FIG. 2—in other words the system and method of FIG. 5 also uses only two nitrogen generators, namely first nitrogen generator (522) and second nitrogen generator (532), and only two air dryers, namely first air dryer (524) and second air dryer (534), instead of three nitrogen generators and three air dryers as used in FIG. 3.

This means that the system (500) and method of FIG. 5 can operate in any one of the following permutations set out below in Table 4. In this Table, each row again represents one of the possible operating permutations, with the first column indicating the compressor that is in use, the second column indicating the nitrogen generator that is in use, and the third column indicating the air dryer that is in use (and with “C1”, “C2”, “N1”, “N2”, “D1” and “D2” having the same meanings as in Table 1).

TABLE 4

| Compressor | Nitrogen Gen | Dryer |
|---|---|---|
| C1 | N1 | D1 |
| C1 | N1 | D2 |
| C1 | N2 | D1 |
| C1 | N2 | D2 |
| C2 | N1 | D1 |
| C2 | N1 | D2 |
| C2 | N2 | D1 |
| C2 | N2 | D2 |

As will again be apparent from the above Table, at any one time one of the air compressors, one of the nitrogen generators and one of the air dryers are not in use and are therefore available as backups for the devices that are in use. Accordingly, in the event of an unexpected or planned shutdown (such as for example in the event of malfunction or required maintenance) of the compressor that is in use, the nitrogen generator that is in use, and/or the air dryer that is in use the production of inert gas and utility air at 100% capacity can be maintained by switching to the use of the compressor, nitrogen generator and/or air dryer that was not in use.

The system and method of FIG. 5 therefore provides similar benefits and advantages to those provided by the system and method of FIG. 3 (i.e. it maintains 100% redundancy while reducing both the required capital expenditure and footprint of the system). In comparison to the system and method of FIG. 3, the system and method of FIG. 5 requires the use and presence of one fewer combined generator, although the combined generators that are used have to be able to accommodate a greater total throughput of compressed air.

As noted above, in each of the embodiments depicted in FIGS. 2 to 5 air compressors are used to provide and supply compressed air to the nitrogen generators and air dryers. However, it should be noted that the present invention is not limited to the use of compressors as the source of compressed air, and in other embodiments other sources of compressed air could be used instead of or in addition to air compressors. For example, one or more air reservoirs pre-filled with compressed air could be used instead of, or in addition to air compressors.

As also noted above, in each of the embodiments depicted in FIGS. 2 to 5 combined generators are used that comprise both a nitrogen generator and an air dryer. An advantage of using such combined generators is that the nitrogen generator and air dryer of a combined generator can utilize and share common pre-treatment equipment, such as for example where a single set of coalescing or particle filters is used and shared by both nitrogen generator and air dryer in order to separate oil or particles from the compressed air stream(s) received by the combined generator before said stream(s) are delivered onwards to the nitrogen generator and/or air dryer. In this way, the space requirements of the system may be further minimized. However, it should be noted that the present invention is not limited to the use of such combined generators, and in other embodiments systems and methods using separate nitrogen generators and air dryers can be used.

It will be appreciated that the invention is not restricted to the details described above with reference to the preferred embodiments, but that numerous modifications and variations can be made without departing from the spirit or scope of the invention as defined in the following claims.

1. A system for use onboard a marine vessel or platform for producing inert gas and utility air onboard the vessel or platform, the system comprising:
a plurality of nitrogen generators comprising a first nitrogen generator for separating nitrogen from air to produce an inert gas comprising nitrogen and a second nitrogen generator for separating nitrogen from air to produce an inert gas comprising nitrogen;
a plurality of air dryers comprising a first air dryer for generating dry utility air and a second air dryer for generating dry utility air;
a plurality of sources of compressed air comprising a first source of compressed air and a second source of compressed air, the first source of compressed air being connected in fluid flow communication with each of the plurality of nitrogen generators and each of the plurality of air dryers, and the second source of compressed air being connected in fluid flow communication with each of the plurality of nitrogen generators and each of the plurality of dryers; and
flow control means operable to selectively prevent or allow fluid flow between the first source of compressed air and each of the plurality of nitrogen generators and plurality of air dryers, and operable to selectively prevent or allow fluid flow between the second source of compressed air and each of the plurality of nitrogen generators and plurality of air dryers;
wherein the system is configured such that during operation of the system at any one time one of the plurality of nitrogen generators is in use and one of the plurality of nitrogen generators is not in use and one of the plurality of air dryers is in use and one of the plurality of air dryers is not use, the flow control means operating to direct flow of compressed air to whichever of said nitrogen generators is in use and whichever of said air dryers is in use.

2. A system as claimed in claim 1, wherein the first source of compressed air comprises a first air compressor, and the second source of compressed air comprises a second air compressor.

3. A system as claimed in claim 2, wherein each of the first air compressor and second air compressor has the capacity to supply sufficient compressed air to simultaneously meet the demands of both the nitrogen generator that is in use and the air dryer that is in use when both said nitrogen generator and said air dryer are operating at maximum capacity.

4. A system as claimed in claim 1, wherein the system is further configured such that during operation of the system at any one time one of the plurality of sources of compressed air is in use and one of the plurality of sources of compressed air is not in use, with the flow control means operating to direct the flow of compressed air from whichever of said sources of compressed air is in use to whichever of the nitrogen generators is in use and whichever of the air dryers is in use.

5. A system as claimed in claim 1, wherein:
the plurality of sources of compressed air further comprise a third source of compressed air in fluid flow communication with each of the plurality of nitrogen generators and each of the plurality of air dryers; and
the flow control means is further operable to selectively prevent or allow fluid flow between the third source of compressed air and each of the plurality of nitrogen generators and plurality of air dryers.

6. A system as claimed in claim 5, wherein the first source of compressed air comprises a first air compressor, the second source of compressed air comprises a second air compressor, and the third source of compressed air comprises a third air compressor.

7. A system as claimed in claim 6, wherein the first air compressor, second air compressor and third air compressor each has the capacity to supply sufficient compressed air to meet the demands of either the nitrogen generator that is in use or the air dryer that is in use when said nitrogen generator or air dryer is operating at maximum capacity.

8. A system as claimed in claim 5, wherein the system is further configured such that during operation of the system at any one time two of the plurality of sources of compressed air are in use and one of the plurality of sources of compressed air is not in use, with the flow control means operating to direct the flow of compressed air from whichever of said sources of compressed air are in use to whichever of the nitrogen generators is in use and whichever of the air dryers is in use.

9. A system as claimed in claim 1, wherein:
the first nitrogen generator and first air dryer are components of a first combined generator capable of receiving and processing compressed air to produce either or both an inert gas comprising nitrogen from the first nitrogen generator and dry utility air from the first air dryer; and
the second nitrogen generator and second air dryer are components of a second combined generator capable of receiving and processing compressed air to produce either or both an inert gas comprising nitrogen from the second nitrogen generator and dry utility air from the second air dryer.

10. A system as claimed in claim 1, wherein:
the plurality of nitrogen generators further comprise a third nitrogen generator for separating nitrogen from air to produce an inert gas comprising nitrogen, and the plurality of air dryers further comprise a third air dryer for generating dry utility air; and
the system is further configured such that during operation of the system at any one time one of the plurality of nitrogen generators is in use and two of the plurality of nitrogen generators are not in use and one of the plurality of air dryers is in use and two of the plurality of air dryers are not use, the flow control means operating to direct the flow of compressed air to whichever of the nitrogen generators is in use and whichever of the air dryers is in use.

11. A system as claimed in claim 10, wherein:
the first nitrogen generator and first air dryer are components of a first combined generator capable of receiving and processing compressed air to produce either an inert gas comprising nitrogen from the first nitrogen generator or dry utility air from the first air dryer;
the second nitrogen generator and second air dryer are components of a second combined generator capable of receiving and processing compressed air to produce either an inert gas comprising nitrogen from the second nitrogen generator or dry utility air from the second air dryer; and
the third nitrogen generator and third air dryer are components of a third combined generator capable of receiving and processing compressed air to produce either an inert gas comprising nitrogen from the third nitrogen generator or dry utility air from the third air dryer.

12. A marine vessel or platform including a system as claimed in claim 1.

13. A method of producing inert gas and utility air onboard a marine vessel or platform, wherein the method uses a system comprising:
a plurality of nitrogen generators comprising a first nitrogen generator for separating nitrogen from air to produce an inert gas comprising nitrogen and a second nitrogen generator for separating nitrogen from air to produce an inert gas comprising nitrogen;
a plurality of air dryers comprising a first air dryer for generating dry utility air and a second air dryer for generating dry utility air;
a plurality of sources of compressed air comprising a first source of compressed air and a second source of compressed air, the first source of compressed air being connected in fluid flow communication with each of the plurality of nitrogen generators and each of the plurality of air dryers and the second source of compressed air being connected in fluid flow communication with each of the plurality of nitrogen generators and each of the plurality of air dryers; and
flow control means operable to selectively prevent or allow fluid flow between the first source of compressed air and each of the plurality of generators and plurality of air dryers, and operable to selectively prevent or allow fluid flow between the second source of compressed air and each of the plurality of nitrogen generators and plurality of air dryers; and
wherein at any one time one of the plurality of nitrogen generators is in a use and one of the plurality of nitrogen generators is not in use and one of the plurality of air dryers is in use and one of the plurality of air dryers is not in use, the method comprising using the flow control means to direct flow of compressed air to whichever of said nitrogen generators is in use and whichever of said air dryers is in use to produce inert gas from said nitrogen generator and utility air from said air dryer.

14. The method of claim 13, wherein at any one time one of the plurality of sources of compressed air is in use and one of the plurality of sources of compressed air is not in use, with the flow control means being used to direct the flow of compressed air from whichever of said sources of compressed air is in use to whichever of the nitrogen generators is in use and whichever of the air dryers is in use.

15. The method of claim 14, wherein for an initial period of time the first source of compressed air is used to provide compressed air, and then during a subsequent period of time the second source of compressed air is used to provide compressed air.

16. The method of claim 13, wherein:
the plurality of sources of compressed air further comprise a third source of compressed air in fluid flow communication with each of the plurality of nitrogen generators and each of the plurality of air dryers; and
the flow control means is further operable to selectively prevent or allow fluid flow between the third source of compressed air and each of the plurality of nitrogen generators and plurality of air dryers; and
at any one time two of the plurality of sources of compressed air are in use and one of the plurality of sources of compressed air is not in use, with the flow control means being used to direct the flow of compressed air from whichever of said sources of compressed air are in use to whichever of the nitrogen generators is in use and whichever of the air dryers is in use.

17. The method of claim 16, wherein for an initial period of time the first and third sources of compressed air are used to provide compressed air, and then during a subsequent period of time the second and third sources of compressed air are used to provide compressed air.

18. The method of claim 13, wherein for an initial period of time inert gas is produced using the first nitrogen generator and utility air is produced using the first air dryer, and then the nitrogen generator and/or the air dryer that is in use is switched such that during a subsequent period of time inert gas is produced using the first nitrogen generator and utility air is produced using the second air dryer, or inert gas is produced using the second nitrogen generator and utility air is produced using the first air dryer, or inert gas is produced using the second nitrogen generator and utility air is produced using the second air dryer.

19. The method of claim 13, wherein:
the plurality of nitrogen generators further comprise a third nitrogen generator for separating nitrogen from air to produce an inert gas comprising nitrogen, and the plurality of air dryers further comprise a third air dryer for generating dry utility air; and
wherein at any one time one of the plurality of nitrogen generators is in use and two of the plurality of nitrogen generators are not in use and one of the plurality of air dryers is in use and two of the plurality of air dryers are not in use, the method comprising using the flow control means to direct flow of compressed air to whichever of the nitrogen generators is in use and whichever of the air dryers is in use to produce inert gas from said nitrogen generator and utility air from said air dryer.

20. The method of claim 19, wherein for an initial period of time inert gas is produced using the first nitrogen generator and utility air is produced using the second air dryer, and then the nitrogen generator or the air dryer that is in use is switched such that during a subsequent period of time inert gas is produced using the third nitrogen generator and utility air is produced using the second air dryer, or inert gas is produced using the first nitrogen generator and utility air is produced using the third air dryer.
